(19) United States
(12) Patent Application Publication
(10) Pub. No.: US 2002/0173276 A1
(43) Pub. Date: Nov. 21, 2002

(54) Method for suppressing spurious noise in a signal field

(76) Inventor: Wolfgang Tschirk, Vienna (AT)

Correspondence Address: Welsh & Katz, Ltd., THOMAS R. VIGIL, 22nd Floor, 120 South Riverside Plaza, Chicago, IL, 60606, US

(21) Appl. No.: 10/094,237

(22) Filed: Mar. 8, 2002

Related U.S. Application Data
(63) Continuation of application No. PCT/AT00/00230, filed on Aug. 28, 2000.

(30) Foreign Application Priority Data
Oct. 9, 1999 (AT) A 1559/99

(51) Int. Cl. H04B 17/00

(52) U.S. Cl. 455/67.3; 455/67.1

(57) ABSTRACT

The invention relates to a method for suppressing spurious noise in a signal field (S2), e.g. in a speech signal spectrum, containing a plurality of signal components which each adopt a value of a signal level and are assigned to an ordinate area (T, F). According to said method, the distribution function (P2(E)) of the signal field is first determined. As a function of the signal level, said distribution function indicates the size of the fraction of those signal components whose signal level is lower than their argument value (E). The signal level values are then modified, based on a comparison between the distribution function (P2(E)) and a reference distribution function which has been obtained from a distribution function that was determined for a set of reference models, whereby the sequece of signal components remains unchanged with regard to their energy level and signal components whose original signal levels are identical, are assigned the same modified signal levels.

### BACKGROUND OF THE INVENTION

1. Field of the Invention

The invention relates to a method for suppressing spurious noise in a signal field containing a plurality of signal components which each adopt a value of a signal level and may be assigned to an ordinate range by which a distribution function of the signal field is determined, said function, as a function of the signal level, indicating, for each of its possible signal level argument values, the size of the fraction of those signal components whose signal level is lower than the argument value.

The signal fields the method according to the invention relates to are used in pattern recognition systems for example to describe the patterns to be recognized.

2. Description of the Related Art

The process of recognizing a pattern usually roughly involves the following steps: detecting the pattern, preprocessing and classification.

The first step, consisting in detecting the pattern, serves to convert the original pattern e.g., words spoken by a user or a piece of paper with a written text provided thereon, to a format suited for processing e.g., in the form of an electronic signal that may be analog or digital coded or of a data file of a given format. The conversion of a signal/data file format e.g., of a raster image, to a format suited for further processing also belongs here. In the case of speech recognition for example, the words spoken by the user are received by an acoustic input unit, such as a microphone for example, if necessary preamplified and converted to an electrical speech signal in analog or digitized form.

The thus detected pattern is provided to the preprocessing unit that reduces the data to be processed and improves the distinguishibility between the patterns to be determined. Preprocessing results in a signal field, in the case of speech recognition in a speech spectrum, that may be provided to the classification system. A substantial step of preprocessing often is a signal analysis of the pattern signal, the electrical speech signal of the user's utterance may for example be submitted to signal analysis by time frame division (discretization) and subsequent Fourier transform, said Fourier transform being carried out for each of the frequency bands and within one time frame respectively, which yields a time-frequency spectrum. At the same time, this generally involves considerable data reduction. Another, perhaps essential step of preprocessing is the reduction of spurious noise in the pattern signal or in the signal field obtained therefrom respectively.

The signal field comprises a plurality of signal components which each adopt a value of their own which is of the same type and is termed here signal level. The signal components are naturally ordered within the signal field, said order being expressed by means of one or several ordinate parameters. A signal field realized as a time-frequency spectrum for example consists of many spectral components that each adopt an energy level of their own; the spectral components are ordered according to time frame and frequency band. Accordingly, in the ordinate range the signal field covers, each signal component may be assigned one range element of the ordinate range so that the range elements cover altogether the ordinate range of the signal field. Depending on the number of ordinate parameters the ordinate range may be one-dimensional, two-dimensional or multidimensional; accordingly, the range elements are line elements, area elements or (n-dimensional) volume elements.

The signal field obtained as a result of preprocessing is provided to the classification system. The system finds out to which recognition class—i.e. in the case of speech recognition a word of a given vocabulary or a word chain—it corresponds. The recognition result is next provided to the output, to a display for example, or is used for further processing e.g., in a command input of a speech oriented facility.

Spurious noise, which interferes with the patterns to be recognized, often makes it more difficult to carry out pattern recognition. The efficiency of a speech recognition system may for example be strongly reduced or even impeded by acoustic background noise.

In known methods for suppressing noise, the noise parameters to which the signal is subject are estimated during preprocessing and a reference noise signal is subtracted on account of this estimation. Such methods of spectral subtraction for voice signals are described by S. V. Vaseghi and B. P. Milner in Noise Compensation Models for Hidden Markov Model Speech Recognition in Adverse Environments”, IEEE Transactions on Speech and Audio Processing, Vol. 5, No. 1, January 1997, pages 11-21. The adequate component of a reference noise signal Eᵣ is hereby subtracted” from the energy level E of a respective one of a spectral component of the spectrum according to the expression

E′=sₛ(E, Eᵣ)=(E^{b}−αEᵣ^{b})^{I/b}

The reference noise signal Eᵣ is simulated on the basis of given or estimated noise parameters. The energy levels may hereby be subtracted with respect to the linear energy levels for example, or in a convolutive” manner in the logarithmic range i.e., in the formula mentioned, the energy levels E, Eᵣ, E′ are replaced by the corresponding logarithms logE, and so on.

The short-coming of the subtraction solution however is that the parameters needed to describe the noise cannot be known as accurately and completely as required. To compensate correctly for the noise it is not only necessary to know the noise amplitudes but the phase relationships as well, which is only possible at great expense if at all. Interferences that do not represent an additive or convolutive superimposition like for example mixed forms of additive and convolutive interferences are even more complicated to handle.

EP 0 062 519 A1 teaches how to eliminate interferences in radar signals, the distribution of the interferences, as contrasted with previously known methods that require a Rayleigh or Weibull interference distribution, although arbitrary, being known. To use the method of this document, it is absolutely necessary to know the distribution, or at least the associated probability density from which it may be derived. Without knowing such a distribution it is not possible to eliminate interferences according to this method.

EP 0 548 527 A2 teaches a method of producing a transform of the level scale of a digital radiographic image, e.g., an X-ray image, that uses a cumulative distribution function of the image to modify the distribution of the image levels in such a manner that they are substantially linear in the range of concern. The object of this invention, namely to represent the image in a form that is appropriate for further examination of the image by looking at it, certainly substantially differs from the object of the present invention.

EP 0 720 358 A2 relates to the compression of video signal data. The level distribution of an image is thereby modified in such a manner that each input level range is assigned an output level range that is the greater the more input levels fall within the first range, the entire output level range being limited. In this case as well, the object, namely a more regular signal compression, substantially differs from that of the present invention. Accordingly, the compression taught in this document does not aim at performing target distribution; the specification for compression only uses parameters derived from the input signal.

None of the documents cited mentions the use of a reference distribution function obtained from training or reference data.

### BRIEF SUMMARY OF THE INVENTION

It is therefore the object of the invention to indicate a method for suppressing noise that reliably reduces signal field impairment caused by spurious noise with regard to subsequent evaluation, more specifically with regard to classification. Furthermore, noise suppression is intended to be capable of being performed without any further knowledge of the noise properties and without simulation of a background noise.

The solution to this object is achieved by a method of the type mentioned herein above by which, in accordance with the invention, a distribution function of the signal field is determined, said function, as a function of the signal level, indicating for each of its possible signal level argument values the size of the fraction of those signal components whose signal level is lower than their argument value, and by which the signal level values of the signal field are then modified on the basis of a comparison of the distribution function with a predetermined reference distribution function, the sequence of the signal components remaining unchanged with regard to their energy level and signal components whose original signal levels are identical, are assigned the same modified signal levels, the function used as a reference distribution function being obtained from a distribution function that was determined for a set of reference models.

This solution permits to suppress noise both for additive or convolutive noise background and for mixed forms or even more complicated interferences. By virtue of the method according to the invention, the effect of the interference on the signal parameters of the signal field may considerably be reduced, even without any further knowledge of the noise parameters.

The requirement demanding that the sequence of the signal components remains unchanged with regard to their energy level means that for any couple of signal components, for which the original level of the first component is smaller than that of the second, the modified level of the first component is not greater (i.e., is equal or smaller) than the modified level of the second component after the modified levels have been assigned to the signal components.

It should be noted that none of the documents mentioned herein above suggest that a modification could be successful using a reference distribution function without taking into consideration the nature of the spurious noise.

The parameter that is essential for the method according to the invention i.e., the reference distribution function, may be determined in advance by means of tests for example. If a training or comparative set of patterns is at hand, said patterns or a selection thereof may serve to create the reference distribution function. As a reference distribution function, a function may then advantageously be used that was determined for a set of reference models. The very distribution function of the set of reference models or a function of the level obtained therefrom e.g., in simplifying the shape of the curve, may hereby be used.

The modification of the signal level values is advantageously performed in that, starting out with dividing the value range of the signal levels into a number of level ranges,

a second level is selected in addition to a first level representing said level range, applying the distribution function and the value of the reference distribution function to the first level, the value of the distribution function approaching as far as possible the value indicated for the reference distribution function, and

those signal components, whose signal level falls between the first and the second level, are assigned the value of the first level for each level range.

This permits to adapt the signal to the reference distribution function to the greatest possible extent. In the simplest case of dividing the signal level value range into level ranges, each occurring signal level is assigned a range of its own so that each level range may be identified together with its signal level.

Furthermore, a particularly suitable realization of the invention is carried out for a signal field realized for a time and/or frequency dependent spectrum of an acoustic signal.

The invention is explained hereinafter with the help of an exemplary embodiment that relates to speech recognition of a spoken word in a motor vehicle.

### BRIEF DESCRIPTION OF THE SEVERAL VIEWS OF THE DRAWINGS

The following accompanying drawings will be referred to:

FIG. 1 is a spectrogram of an utterance under noise-free conditions;

FIG. 2 shows the energy distribution function relative to the spectrogram of FIG. 1;

FIGS. 3 and 4 are a spectrogram and the corresponding energy distribution function of an utterance with noise background;

FIGS. 5 and 6 are a spectrogram and the corresponding energ distribution function obtained from spectral subtraction from spectrogram of FIG. 3;

FIG. 7 is a reference distribution function for using the invention;

FIGS. 8 and 9 are a spectrogram and the corresponding energ distribution function obtained from spectrogram of FIG. 3 by means of the noise reduction of the invention and with the help of the reference distribution function of FIG. 7.

### DETAILED DESCRIPTION OF THE INVENTION

Speech signals that are spoken on a noise background like for example the noise prevailing within a motor vehicle in operation, are impaired by noise originating from diverse sources such as the motor of the car, other vehicles, wind, and so on and often representing a mixture of sound components of high energy, the statistic of which, with regard to time lapse and frequency, cannot be predicted. As a result thereof, the efficiency of speech recognition systems rapidly decreases as the noise background increases due for example to the increasing vehicle speed. The exemplary embodiment of the invention represented herein below is related to the recognition of the English words ,zero', ,one', ,two', and so on up to ,nine' for the FIGS. 0 through 9 using a speech recognition system in a vehicle of the subcompact car type.

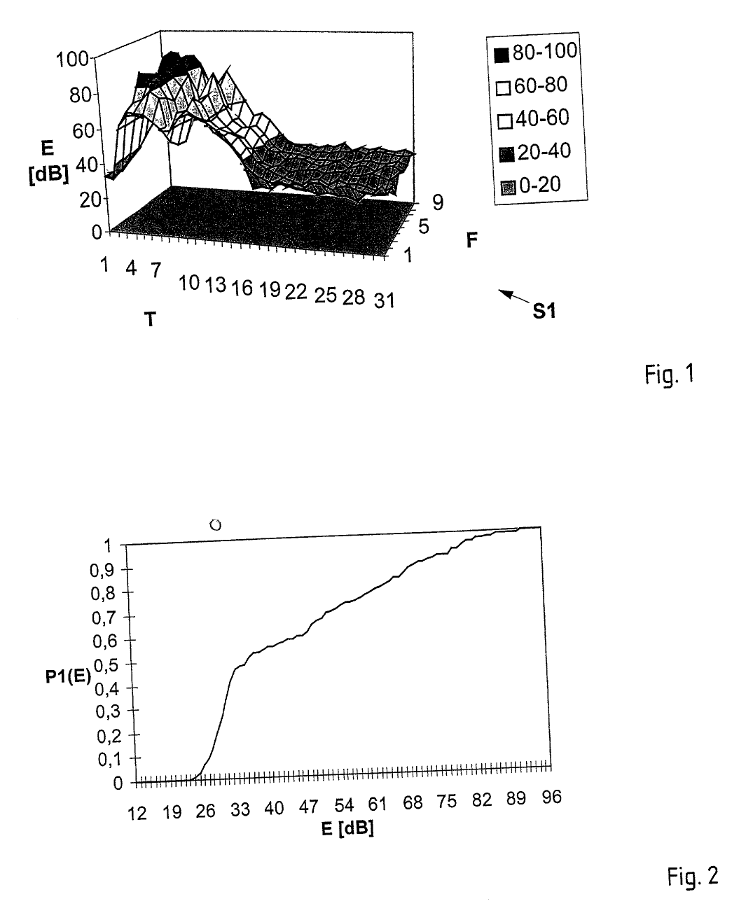

FIG. 1 shows a spectrogram SI of a spectrum of the English word ,seven' spoken in the car under noise-free conditions by a male speaker.

In the spectra dealt with in the exemplary embodiment, the time axis covers a period of 0.992 s which is divided into 31 frames T of the same duration (so-called ‘frames’). The frequency range extends from f=200 Hz to 3.4 kHz and is divided into 9 bands F, the width and spacing of which have a logarithmic gradation. In all of the FIGS., the spectral energy is represented as energy level E in a logarithmic representation using the unit dB and related to a level of background noise that is the same for all of the Figs.

In speech recognition tests of the applicant such type spectra were used for utterances concerning the vocabulary mentioned. In the speech recognition system used, preprocessing of the utterance to be recognized is followed by a classification that is performed by means of noise suppression as will be explained in more detail herein after, a layered neural network that was trained with training vocabulary serving as a pattern recognition system. The training vocabulary was constituted in that a number of—advantageously both male and female—speakers spoke the vocabulary in an environment corresponding to the speaking environment in the car, each word being uttered several times under noise-free conditions of the background (car at rest).

FIG. 2 shows the energy distribution function P1 (E) of the spectrum S1 shown in FIG. 1. An energy distribution function P(E) allocated to a spectrum S indicates, as a function of the energy level E, how many of the spectral components S(T, F) of the spectrum S of concern are provided with an energy level that is lower than the energy level E indicated, this number being expressed as a value comprised between 0 and 1 related to the total number of the spectral components. At 48 dB for example, the energy distribution function P1 has the value 0.6, for 60% of the energy levels of spectrum S1 are lower than 48 dB. A great (small) gradient in the energy distribution function P(E) corresponds to an energy level whose value appears in a great (small) number of components of the corresponding spectrum S. An energy distribution function may also be determined for a plurality of spectra, said function indicating in this case the share of the components of all the spectra having an energy level lower than the level E indicated, divided by the total number of the components of all of these spectra.

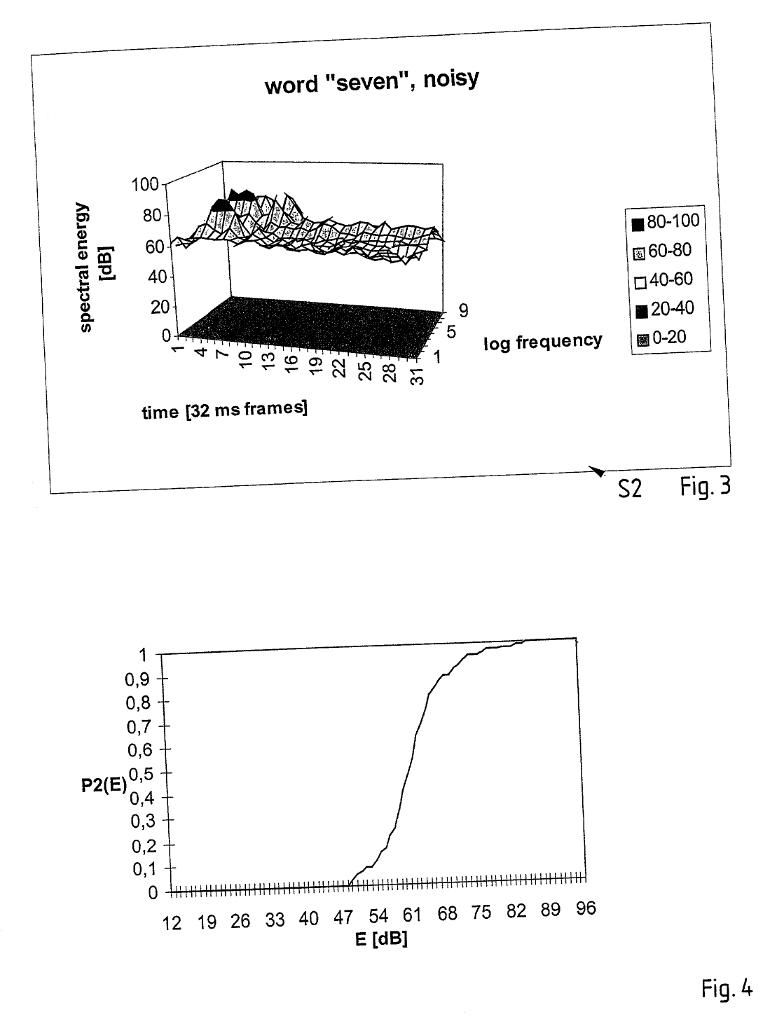

FIG. 3 shows the spectrogram S2 of a word spoken by the same speaker at a car speed of 113 km/h (70 mph). It is apparent from the comparison of the spectrograms S1 and S2 (FIG. 1 and 3 respectively) that only the speech parts of high energy remain but little impaired whereas the other parts are masked by the noise. The background energy level rises from about 25 dB to about 65 dB, the peaks of the utterance amount to 85 dB, the speech parts of less than 70 dB get lost in the noise background. The corresponding energy distribution function P2(E) is represented in FIG. 4.

The energy distribution functions P1 and P2 (FIGS. 2 and 4 respectively) show that the spectral distribution of the noise-free signal S1 differs considerably from that of the noised signal S2 in which the background energy is about 40 dB higher than in the case of the noise-free signal.

The noise of the noisy signal may be reduced by means of the afore mentioned spectral subtraction according to S. V. Vaseghi and B. P. Milner. According to what has been said herein above, the spectrum S is transformed using a reference noise signal Sᵣ by subtracting”, in each spectral component S(T, F), the respective one of the components Sᵣ (T, F) of the reference noise according to the expression

S′(T, F)=E0=sₛ(E, Eᵣ)=(E^{b}−αEᵣ^{b})^{I/b},

where

E=S(T, F)

and

Eᵣ=Sᵣ(T, F)

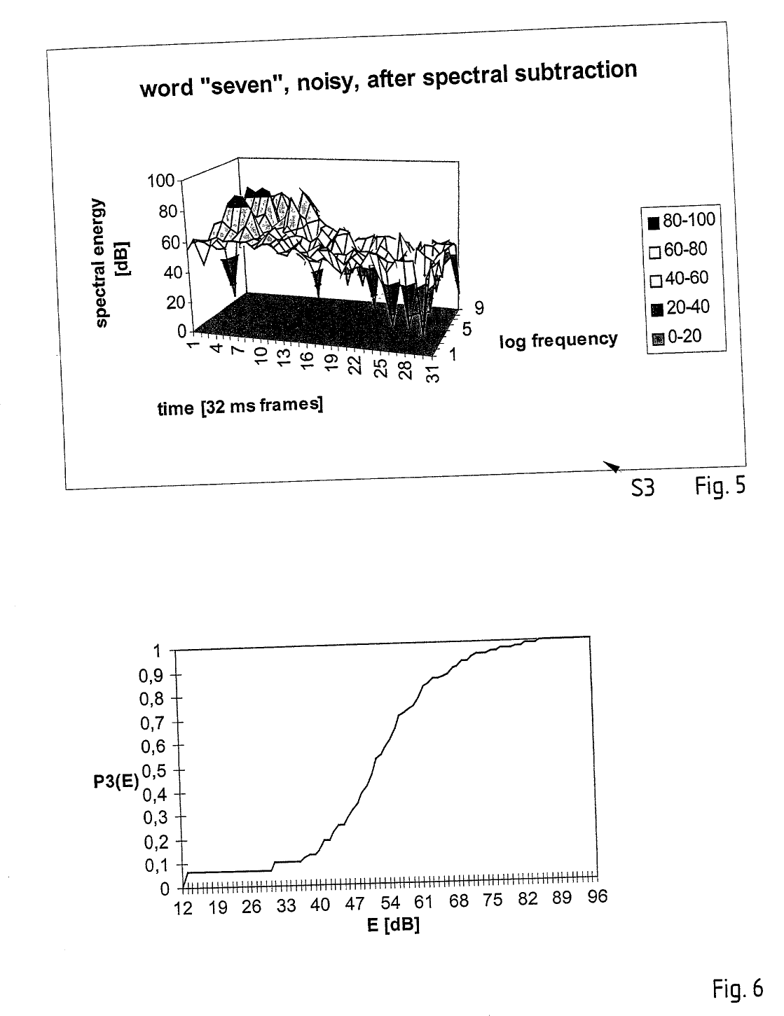

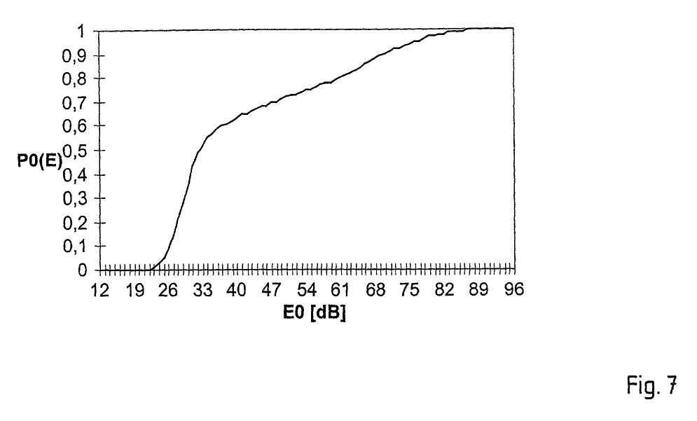

Noise reduction after spectral subtraction was carried out for spectrum S2 within the frame of the applicant's tests described herein after. The FIGS. 5 and 6 illustrate the spectrum S3=sₛ (S2, Sᵣ), which is obtained in applying the spectral subtraction to the spectrogram S2, and the corresponding energy distribution function P3; the parameters b and ″ used were those at which the results of the speech recognition tests performed were best for various parameters b and ″, and a reference noise Sᵣ obtained from the reception of the voiced speech S2 was also used. As can be seen from the FIGS. 5 and 6, the background noise is approximately 10 dB lower than in the untreated signal S2. However, a considerable share of the low energy speech parts still remain covered by residual noise. This is the reason why the success ratio of speech recognition improves but slightly.

As the signal used as a reference noise signal Sᵣ corresponds only statistically to the noise constituting the background of the noisy signal S2, spectral subtraction only permits to reduce the noise level for individual components of the spectrum S3 obtained. For, depending on the relative phase position of the reference noise and of the actual background, the noise part of a component is only canceled for part of the components of the spectrum whereas in other components the level remains approximately the same and in some, it is even amplified (although the amplification effect is attenuated on account of the logarithmic representation of the energy levels). This can be surveyed from FIG. 5 and there particularly from the low level shares from time frame 20 onward approximately.

In accordance with the invention, noise suppression for the voice signal S2 is performed using a given pattern function” i.e., an energy distribution function that serves as a reference. This advantageously occurs in such a manner that the levels of the spectral components of the speech signal spectrum S2 are adapted to the pattern function. The energy distribution function of the spectrum obtained then substantially squares with the pattern function.

Ideally, the pattern function used would be the energy distribution function of the sum of those spectra that are used for the word of concern (here ,seven') in training the speech recognition system; as the speech recognition system naturally does not know the word to be recognized, this is not possible. The function selected instead as a pattern function is a function that is appropriate with regard to the totality of the words of the vocabulary to be recognized. The energy distribution function used as a pattern function P0 may for example be the function that was derived from the spectra of the entire training vocabulary.

The noise suppression in accordance with the invention, which is performed in adapting the levels to a pattern function, occurs in such a manner that spectral components whose levels E=S (T, F) are originally identical, have still the same level E0=S'(T, F) after adaptation i.e., the adaptation condition

S′(T₁_{^{′}}F₁)=S′(T₂_{^{′}}F₂) when S(T₁_{^{′}}F₁) =S(T₂_{^{′}}F₂) (1)

applies to all of the spectral components.

Furthermore, the sequence of the components with respect to their energy levels is not to be modified which is to say that

S′(T₁_{^{′}}F₁)≦S′(T₂_{^{′}}F₂) when S(T₁_{^{′}}F₁) <S(T₂ _{^{′}}F₂) (2)

this monotony condition keeps the structures of the spectrum at least from a qualitative point of view when suppressing noise of spectrum S in a modified spectrum S′.

As a consequence of the adaptation condition (1), noise suppression may be described completely by an adaptation function R(E) that assigns to each original level E a modified level E0=R(E), those spectral components that originally had the level E being lowered (or raised) to said modified level. The adaptation function is monotonous on account of the monotony condition (2) i.e., R(E₁)≦R(E₂) when E₁<E₂. In accordance with the invention, this adaptation of the spectrum occurs in such a manner that P0(E0)=P(E) applies to the corresponding energy distribution function. Therefore, the adaptation function R(E) is clearly determined by comparing the energy distribution function P2 of the signal at hand with the pattern function P0. Since the energy distribution functions P, P0 are likewise monotonic functions, the adaptation function can be determined formally therefrom by reversing the pattern function P0.

Table 1 shows an exemplary program pseudocode by means of which the adaptation of a spectrum is performed in accordance with the invention. The spectrum S to be adapted is hereby saved in the field variable S that is defined by way of the intervals Tmin..Tmax and Fmin..Fmax of the time-frequency domain. The energy levels of the spectrum may adopt discrete values in the value range between the energy levels Emin and Emax. A reference energy distribution function is given as a pattern function in the field variable P0. The energy distribution functions are defined as fields over the interval Emin..Emax mentioned.

At first, the corresponding energy distribution function is determined (from mark PS/S) and stored in the field variable PS. For this purpose, the level value is determined for each component S″T, F> of the spectrum, and all of the components of the energy distribution function PS,

```
TABLE 1
{PS/S}
for E = Emin to Emax:
  PS[E] = 0;
end for;
for T = Tmin to Tmax:for F = Fmin to Fmax:
  for E = S[T, F] to Emax:
    inc (PS[E]);
  end for;
end for; end for;
{RED/S}
for E0 = Emin to Emax:
  if P0[E0] > PS[E0]:
  dE = 0;
  while E0 + dE <= Emax
      and abs (P0[E0]−PS[E0+dE]) <= abs (P0[E0]−PS[E0+dE−1]):
    inc (dE);
  end while;
  dec (dE);
  if dE > 0:
    for T = Tmin to Tmax:for F = Fmin to Fmax:
      if S[T, F] > E0 and S[T, F] <= E0 + dE:
        S[T, F] = E0;
      end if;
      end for; end for;
    end if;
  end if;
end for;
```

whose corresponding energy level is in excess of this level value, are incremented. inc thereby designates the increment function.

Next, (from mark RED/S), the following steps are performed in a for-loop for each of the discrete values E0 inasmuch as, at this level, the energy distribution function PS [E0] is smaller than the pattern function P0 [E0]: an energy level E0+dE assigned to the level value E0 is first determined. This is performed in incrementing the spacing dE of these levels (while-loop), starting from the value 0, until the value of the energy distribution function at the corresponding level PS [E0+dE] approaches most the value of the pattern function at the given level value P0 [E0]. For this purpose the function abs is used to determine the absolute amount. The decrementing step dec (dE) which occurs after the while-loop serves to correct the value to such a value to which the condition mentioned actually applies. Now, the level value EO represents the modified level of energy level E0+dE. It is next checked whether the level spacing dE is positive (greater than 0); in this case, all of the components S[T, F] of the spectrum whose energy level falls within the interval between E0 and E0+dE, are set to the energy level E0. After the external for-loop has been passed for the last time, the field S contains the noise suppressed spectrum S′ of the invention.

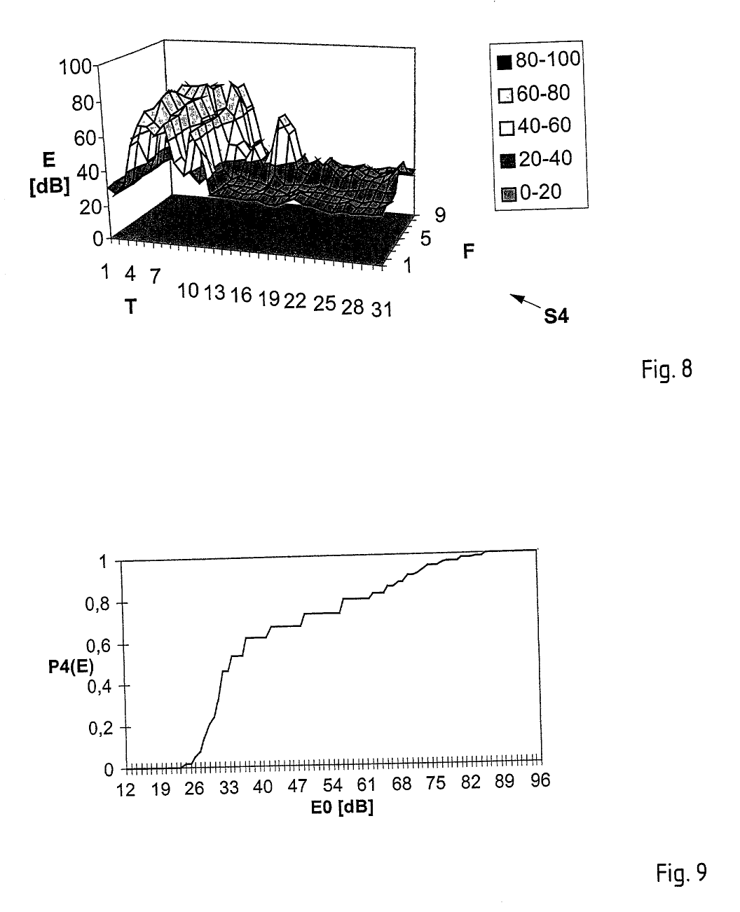

FIG. 7 shows the pattern function P0(E0) used in the exemplary embodiment, namely the energy distribution function for the training vocabulary mentioned herein above, i.e., the English figures ,zero' through ,nine'. For the noised utterance S2, the noise suppression according to the invention yields, with the help of the pattern function P0 mentioned, the spectrum shown in FIG. 8 in the form of spectrogram S4; the corresponding energy distribution function P4 is depicted in FIG. 9.

To simplify the execution of the method in accordance with the invention, a respective one of the level ranges of the original spectrum may be treated together in such a manner that the corresponding spectral components are allocated one uniform modified level. Said modified level is determined as described above, by means of the adaptation function for example, with regard to a representative level value of the level range of concern e.g., to the mean value of the level range or the median of the levels over the components falling within said level range.

The method in accordance with the invention was tested with the speech recognition system described herein above in first speech recognition tests performed by the applicant and was concurrently compared to the method of spectral subtraction. The utterances to be recognized were spoken under different conditions of noise background, namely at speeds of 80 km/h (50 mph) and at 113 km/h (70 mph). Those events were counted in which the utterance was recognized incorrectly by the speech recognition system, substitution errors only having been taken into consideration. In a control row in which the signals were provided to the pattern recognition without noise reduction , 30% of the utterances were incorrectly recognized. Using spectral subtraction as a noise suppression method, the incorrect recognitions obtained only amounted to 23.3%. With the method in accordance with the invention, the incorrect recognitions were reduced to 13.3% i.e., the error rate was reduced by almost half as compared to the known method.

The method according to the invention is particularly suited to suppress interferences that hardly if at all disturb the monotony relation of the spectral components of the utterance. Such interferences include for example white noise, a linear or non-linear amplification or attenuation of the entire spectrum, as well as phenomena of the Lombard Effect wherein the voice and the pronunciation change as a function of the psychic state of the speaker, stress for example.

In spectrogram S4 of FIG. 8 an artifact may be seen about time frame 16 in the upper frequency bands; said artifact is not contained in the actual utterance (FIG. 1) and has not been eliminated by the method in accordance with the invention. In most cases, such artifacts can be eliminated by means of a median filtering unit mounted downstream of the noise suppression for example.

The method for suppressing noise in accordance with the invention also modifies the signal to be processed when there is no noise at all as the pattern function P0 generally differs from the energy distribution function of the undisturbed utterance. In certain cases, this may constitute a source of recognition errors in the noise-free case. To avoid this, the training of the speech recognition system may for example be carried out with the help of spectra that have already been adapted to the pattern function used by means of the method in accordance with the invention. The training vocabulary may contain these spectra instead of or together with the original spectra.

Another possibility consists in only utilizing the method in accordance with the invention when noise is detected e.g., in the period of time just before the utterance; otherwise, the speech signal of the speech recognition is provided without noise suppression. This possibility does not require the noise to be estimated; it merely has to be detected.

In a simplified variant of the method in accordance with the invention, the adaptation of the spectrum can be considerably simplified in only using a determined number of parameters of the pattern function and in carrying out the adaptation with regard to these parameters. The mean value and the scattering of the distribution of the pattern function could be used for example. Mean value and scattering of the distribution of the energy distribution function are likewise determined for adaptation and a linear transform is determined for the energy levels of the spectrum by comparing these parameters with those of the pattern function. In using this linear transform, a modified spectrum is obtained in which the disturbing effect of the background noise is considerably reduced. If the use of a linear transform is not sufficient, a higher degree transform may be used, said higher degree transform being determined by comparison of a corresponding number of parameters of the energy distribution function with those of the pattern function, such as higher moments of the distributions for example.

The method in accordance with the invention is not only suited to interference reduction in acoustic signals such as speech signals for example; it may also be used for other kinds of patterns that can be described by a feature value assigned to a one-dimensional or multi-dimensional field. Accordingly, possible ranges of application are e.g., character recognition of written text or the like, reconstruction and/or interpretation of images, and so on.

I claim:

1. A method for suppressing spurious noise in a signal field (S2) containing a plurality of signal components which each adopt a value of a signal level and are assigned to an ordinate area (T, F),
in which a distribution function (P2(E)) of the signal field (S2) is determined, said function, as a function of the signal level, indicating, for each of its possible signal level argument values (E), the size of the fraction of those signal components whose signal level is lower than the argument value (E),
wherein
the signal level values of the signal field (S2) are modified in such a manner that the distribution function P4 (E) of the modified signal field (54) equals a predetermined reference distribution (PO(E)), the sequence of the signal components remaining unchanged with regard to their energy level and signal components, whose original signal levels are identical, being assigned the same modified signal levels,
the reference distribution function (P0) used being a function obtained from a distribution function that was determined for a set of reference models.

2. The method of claim 1, wherein, to modify the signal level values, starting out with dividing the value range of the signal levels into a number of level ranges,
a second level is selected in addition to a first level (E0) representing said level range, applying the distribution function (P2) and the value of the reference distribution function to the first level (P0(E0)), the value of the distribution function (P2(E)) for said second level approaching as far as possible the value indicated for the reference distribution function (P0(E0)), and
those signal components, whose signal level falls between the first and the second level, are assigned the value of the first level (E0)
for each level range.

3. The method of claim 1, wherein it is carried out for a signal field realized for a time and/or frequency dependent spectrum of an acoustic signal.

4. The method of claim 2, wherein it is carried out for a signal field realized for a time and/or frequency dependent spectrum of an acoustic signal.
